(19) United States
(12) Patent Application Publication
(10) Pub. No.: US 2021/0154501 A1
(43) Pub. Date: May 27, 2021

(54) FIRE SUPPRESSION FOR ADDITIVELY MANUFACTURED ARTICLE

(71) Applicant: The Boeing Company, Chicago, IL (US)

(72) Inventors: William Ryan Cooper, Maple Valley, WA (US); Kirk D. Skaggs, Kent, WA (US)

(21) Appl. No.: 16/692,067

(22) Filed: Nov. 22, 2019

(51) Int. Cl. A62C 3/00; A62C 99/00; B29C 64/364

(52) U.S. Cl. CPC A62C 3/00; B33Y 80/00; B29C 64/364; A62C 99/0009

(57) ABSTRACT

An additively manufactured article is described. The additively manufactured article comprises a body, a plurality of channels integrated in the body, and an inlet fluidically coupled to at least one of the channels. The additively manufactured article further comprises pressurized fire suppressant in at least one of the channels.

The application relates to fire suppression, and more particularly to fire suppression for additively manufactured articles.

### BACKGROUND

Additive manufacturing encompasses a variety of techniques that enable the formation of three-dimensional parts, typically through layer-by-layer material deposition. Part formation can take place across a wide variety of scales. For example, some large-scale implementations of additive manufacturing provide material deposition rates above 150 lb/hr, allowing relatively large parts (e.g., on the order of 1000 lbs.) to be formed in reasonable time frames. Part formation can also involve a wide variety of materials, such as thermoplastics. One thermoplastic known as acrylonitrile butadiene styrene (ABS) has been used for its relatively low cost and, in many use cases, its ability to be formed near 350° F. for use below 260° F.

ABS and other thermoplastics, as well as some non-thermoplastic materials, are flammable, however. For smaller-scale manufacturing, the risks posed by flammable materials is somewhat mitigated by the relatively smaller size of formed parts. Large-scale manufacturing, however, may present greater flammability concerns due to the larger mass of flammable material in formed parts. Flammability is compounded where multiple large-scale parts are in proximity, for example on a common factory floor.

To address the concerns of flammability in the presence of large-scale parts, regulations may be placed on the storage and/or use of such parts. For example, constraints may be placed on the number of parts stored on a common factory floor, their proximity, and/or their physical characteristics such as dimensions and weight. Such constraints, however, may reduce the utilization of factory space and limit manufacturing throughput, thereby adversely affecting economics and scalability.

Thus, and in view of the above, challenges exist in manufacturing and storing additively manufactured parts, and managing risks posed by the flammability of such parts.

### SUMMARY

To address the above issues, according to one aspect of the present disclosure, an additively manufactured article is provided. In this aspect, the additively manufactured article comprises a body, a plurality of channels integrated in the body, and an inlet fluidically coupled to at least one of the channels. The additively manufactured article further comprises pressurized fire suppressant in at least one of the channels.

Another aspect of the present disclosure relates to a method of mitigating fire risk in an additively manufactured article. In this aspect, the method comprises fluidically coupling an inlet of the article to a reservoir comprising fire suppressant, the inlet fluidically coupled to at least one channel of a plurality of channels integrated in a body of the article, and delivering the fire suppressant via the inlet to the at least one channel.

Another aspect of the present disclosure relates to an additively manufactured article. In this aspect, the additively manufactured article comprises a body and a plurality of channels integrated in the body. The additively manufactured article further comprises a plurality of inlets, wherein each inlet of the plurality of inlets is fluidically coupled to at least one of the channels, and each inlet of the plurality of inlets is fluidically coupled to a reservoir comprising fire suppressant.

The features, functions, and advantages that have been discussed can be achieved independently in various embodiments or can be combined in yet other embodiments, further details of which can be seen with reference to the following description and drawings.

### BRIEF DESCRIPTION OF THE DRAWINGS

FIG. 1 shows an illustration depicting an example environment in which a plurality of additively manufactured articles is located.

FIG. 2 shows an illustration depicting a cross-sectional view of an additively manufactured article taken along line A-A in FIG. 1 according to one example of the present disclosure.

FIG. 3 shows an illustration depicting an additively manufactured article pressurized with fire suppressant according to one example of the present disclosure.

FIGS. 4A and 4B show illustrations depicting front and rear views, respectively, of the additively manufactured article of FIG. 3.

FIG. 5 shows another example of an additively manufactured article in which fire suppressant is circulated through the article according to one example of the present disclosure.

FIG. 6 shows an illustration depicting a rear view of the additively manufactured article of FIG. 5.

FIG. 7 shows an illustration depicting another additively manufactured article including inlets and outlets according to one example of the present disclosure.

FIG. 8 shows an illustration depicting another additively manufactured article configured to conduct fire suppressant.

FIG. 9 shows an illustration depicting a rear view of the additively manufactured article of FIG. 8.

FIG. 10 shows a flowchart illustrating a method of mitigating fire risk in an additively manufactured article.

### DETAILED DESCRIPTION

In view of the considerations discussed above, articles and methods are provided that relate to mitigating fire risk in additively manufactured articles. Briefly, channels with fire suppression capability are integrated within the body of an additively manufactured article during the manufacturing process. In some examples, the channels are pressurized with a fire suppressant. When an ignition source burns an opening through the article body and exposes a channel, the pressurized suppressant is released through the opening and directed toward the ignition source. In other examples, the channels are fluidically coupled to a fire suppression system that releases fire suppressant into the channels in response to a trigger, such as optical detection of an ignition source. In this manner, additively manufactured articles are formed with self-extinguishing capabilities that mitigate flammability risks associated with the material composition of the articles. As noted above, providing such self-extinguishing capabilities may be particularly advantageous for large-scale additively manufactured articles.

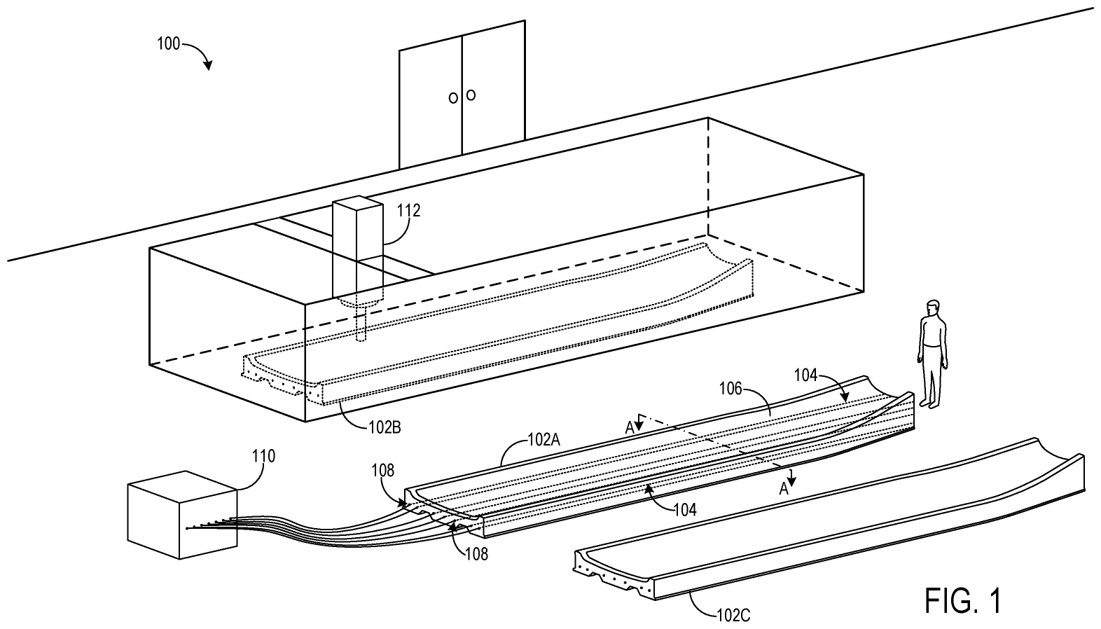

FIG. 1 illustrates an example environment 100 in which a plurality of additively manufactured articles 102 is located. Articles 102 can comprise any suitable material(s) that can be used to additively manufacture the articles. As examples, articles 102 may comprise a thermoplastic such as acrylonitrile butadiene styrene (ABS) and/or another styrene, an acrylic, a polycarbonate, and/or nylon. As another example, articles 102 may comprise an injection molding plastic.

In some examples, articles 102 comprise flammable material(s) such as ABS. As such, articles 102 may pose a flammability risk in environment 100 due to their potential ability to provide a fuel source for fire. This risk increases as the size and volume of material of the articles increases. In some examples, articles 102 may assume relatively large weights (e.g., on the order of 1000 lbs. or heavier) and/or dimensions (e.g., 35′×5′ or greater) that create significant masses of flammable material. The flammability risk is also exacerbated where articles 102 are co-located in a common environment, as illustrated in the example of FIG. 1.

To address the flammability risk created by articles 102, a fire suppression mechanism such as an overhead sprinkler system can be provided in environment 100. However, such mechanisms may be incapable of sufficiently suppressing fire at articles 102, for example as a result of failing to specifically target the articles 102. Further, the untargeted release of fire suppressant from such systems can damage other articles and items in environment 100.

In some examples, alternative fire suppression mechanisms can be used, such as a system configured to release a halogen-based suppressant. However, halogen-based suppressants can undesirably change the material characteristics of some additively manufactured articles (e.g., by rendering the articles brittle), and may incur significant additional cost. Yet other approaches may rely on human labor to suppress fire, for example using portable extinguishers. Such approaches are prone to human error and also pose risk to human operators.

In view of the above, the present disclosure provides articles 102 manufactured with integrated channels that provide self-extinguishing capabilities to mitigate fire risks. FIG. 1 schematically depicts an additively manufactured article 102A comprising a plurality of channels 104 within a body 106 of the article, where each channel 104 is configured to conduct a fire suppressant. Each channel 104 is fluidically coupled via a corresponding inlet 108 to a reservoir 110 containing fire suppressant and configured to deliver the fire suppressant to channels 104. In the example of FIG. 1, the reservoir 110 is fluidically coupled to a pumping system (not shown) that delivers the fire suppressant to channels 104. In different examples, any suitable type of fire suppressant may be supplied to the additively manufactured articles described herein. As examples, a fire suppressant can include an inert gas (e.g., nitrogen, argon, carbon dioxide), a halogen, a liquid that vaporizes when discharged from a channel, and mixtures thereof.

As described in further detail below, fire suppressant can be delivered to channels 104 in a variety of different manners and configurations. In some examples, channels 104 are pressurized with fire suppressant received from reservoir 110, and the fluidic coupling between reservoir 110 and channels 104 is maintained. Accordingly, when a high heat situation causes the body material surrounding a channel 104 to soften, the pressurized fire suppressant within the channel escapes through the damaged area to flood the article and adjacent environment with fire suppressant. As the fire suppressant escapes, the fluidically coupled reservoir 110 supplies additional suppressant to the damaged area and other channels in the article.

In another example and as described in more detail below, fire suppressant in the reservoir 110 is not delivered to channels 104 until a triggering event is detected. In this example and absent a triggering event, the channels 104 do not contain fire suppressant. When a triggering event occurs, such as detection of an ignition source at or near the article 102, the reservoir 110 delivers fire suppressant to the article and pressurizes the suppressant within the channels 104 and/or expels the suppressant from outlets in the article.

In some examples, reservoir 110 is fluidically coupled to multiple articles 102 to provide fire suppressant thereto. In some examples, after the channels 104 in an article 102 have been pressurized, the reservoir 110 can be fluidically disconnected from channels 104 to allow the article 102—containing fire suppressant—to be moved.

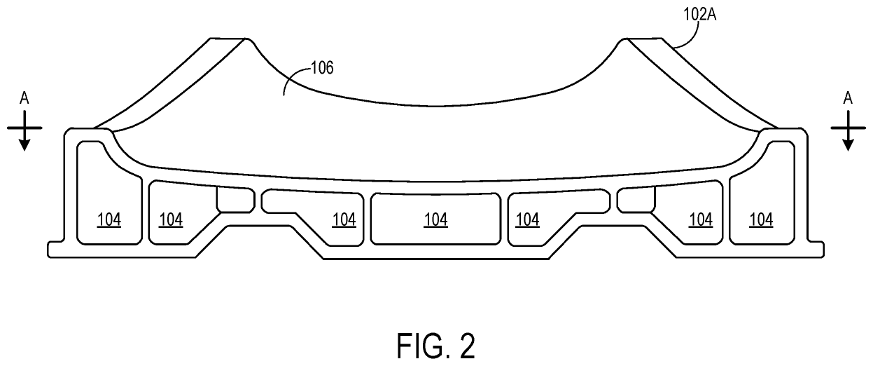

FIG. 2 shows a cross-sectional view of article 102A taken along line A-A in FIG. 1, illustrating an arrangement of channels 104 in body 106 of the article. In the depicted example, channels 104 are arranged substantially in parallel and in a common layer (e.g., in substantial lateral alignment). Further, as can be seen from FIGS. 1 and 2, channels 104 extend along substantially the entire length of article 102A.

In other examples of additively manufactured articles, one or more channels may be arranged with any suitable geometry and placement. For example, channels may be formed with curvature—e.g., in a snaking, irregularly curved, or spiral path—and/or in different layers of the body. As another example, multiple channels may be fluidically coupled and arranged to traverse a single path throughout the body of the article. In other examples, channels extend along a portion, and not the entirety, of the length of the article.

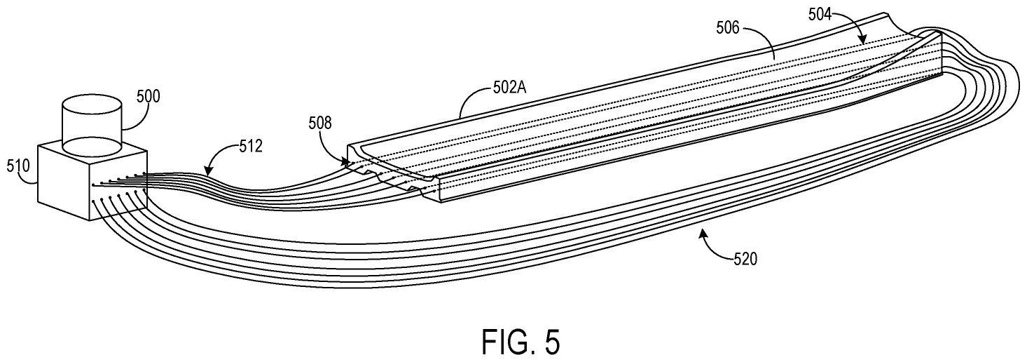

In the example article 102A of FIGS. 1-4 and as described in further detail below, ends of channels 104 are enclosed with plates 400, 404 at the terminal ends of the article. One or both plates can include inlets that fluidically couple the channels 104 to the fire suppressant reservoir 110 as described above. Additionally and in some examples, a plate includes one or more outlets that fluidically couple channels to return lines that provide the fire suppressant back to the reservoir 110, thereby enabling circulation of fire suppressant through the article 102A. Alternatively, the outlets can be open to atmosphere. Additional detail regarding such implementations is described below with reference to FIGS. 5-9.

Articles 102 may be manufactured via any suitable additive manufacturing techniques. Examples include but are not limited to 3D printing; material extrusion; additive friction stir deposition; direct energy deposition; direct metal printing; electron beam additive manufacturing; electron beam melting; electron beam powder bed manufacturing; fused deposition modeling; indirect powder bed manufacturing; laser cladding; laser deposition manufacturing; laser deposition welding; laser deposition welding/integrated milling; laser engineering net shaping; laser freeform manufacturing; laser metal deposition with powder; laser metal deposition with wire; laser powder bed manufacturing; laser puddle deposition; laser repair manufacturing; powder directed energy deposition; stereolithography; selective laser melting; small puddle deposition; or combinations thereof.

With reference again to FIG. 1, in some examples articles 102 are both manufactured and connected to fire suppressant reservoir 110 in environment 100. In the example of FIG. 1, an additive manufacturing machine 112 is configured to fabricate articles 102 including article 102A. During the manufacture of article 102A, machine 112 forms channels 104 comprising voids within body 106. In addition to providing self-extinguishing capabilities as described herein, such voids also reduce material consumed in fabrication and lower the final weight of article 102A. As one example, machine 112 may comprise a material extrusion additive manufacturing machine that forms articles 102 by extruding heated thermoplastic compound(s) through an orifice. The extruded material forms borders and segments that are sequentially deposited to build up the article bodies.

In other examples, an environment 100 in which articles 102 are connected to fire suppressant reservoir 110 is different from the environment in which articles 102 are manufactured. In some of these examples, machine 112 can take the form of a device that processes parts supported by an article 102B. For example, article 102B may be configured as a layup mandrel —e.g., for providing a layup surface for curing, finishing, or performing other work on composites and/or other materials. In other examples, an article 102 may be configured as a tooling fixture. For example, machine 112 may be a numerically controlled milling machine configured to machine parts that are secured by an article of the present disclosure that is configured as a mill fixture. In other examples, articles 102 may be configured and utilized for any suitable purpose.

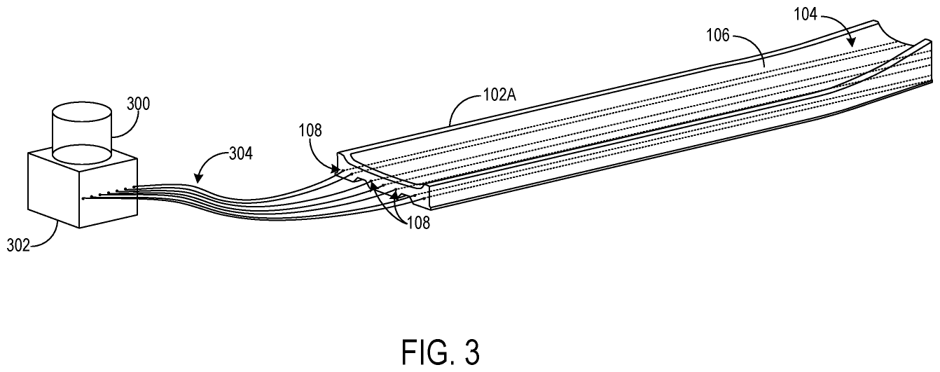

As described above, in some examples channels of an article are pressurized with fire suppressant. FIG. 3 illustrates one such implementation in which channels 104 of article 102A are pressurized with fire suppressant held by a reservoir 300. In this example, reservoir 300 supplies fire suppressant via pumping system 302 and supply lines 304 to inlets 108. Each of the inlets 108 is fluidically coupled to a corresponding channel 104 in the body 106 of article 102A. In different examples, supply lines 304 are coupled to inlets 108 via quick disconnect couplings, or via any other suitable mechanism.

In some examples, reservoir 300 and pumping system 302 are configured as a portable unit. In these examples, reservoir 300 and pumping system 302 can be moved within an environment or to different locations where they are fluidically coupled to one or more articles. Reservoir 300 and pumping system 302 may travel with a particular article 102A as the article is moved (e.g., within environment 100 or another environment). In some examples, reservoir 300 and pumping system 302 are removably attached to article 102A. Any suitable attachment mechanism may be used to secure reservoir 300 and pumping system 302 to article 102A, including but not limited to a receptacle integrated in the article during manufacture of the article. In other examples, reservoir 300 and pumping system 302 may be configured as a stationary unit (e.g., in environment 100).

In some examples, reservoir 300 and pumping system 302 are fluidically disconnected from inlets 108 after pressurizing channels 104. In these examples, the inlets 108 are sealed to retain pressurized fire suppressant within the channels. In this manner, an article 102 is both mobile and embodied with self-extinguishing capabilities. To facilitate the delivery and sealing of suppressant in channels 104, in some examples each inlet 108 may include a one-way valve, for example. Any other suitable mechanisms for retaining fire suppressant in the channels may be used. In other examples and as noted above, the fluidic coupling between the reservoir 300 and channels 104 may be maintained, including during a breach in the containment of pressurized suppressant in channels 104 by an ignition source. In these examples, reservoir 300 can provide additional suppressant to channels 104 as the previously delivered suppressant is expressed out from one or more channels and body 106, thereby maintaining at least partial channel pressurization for a duration.

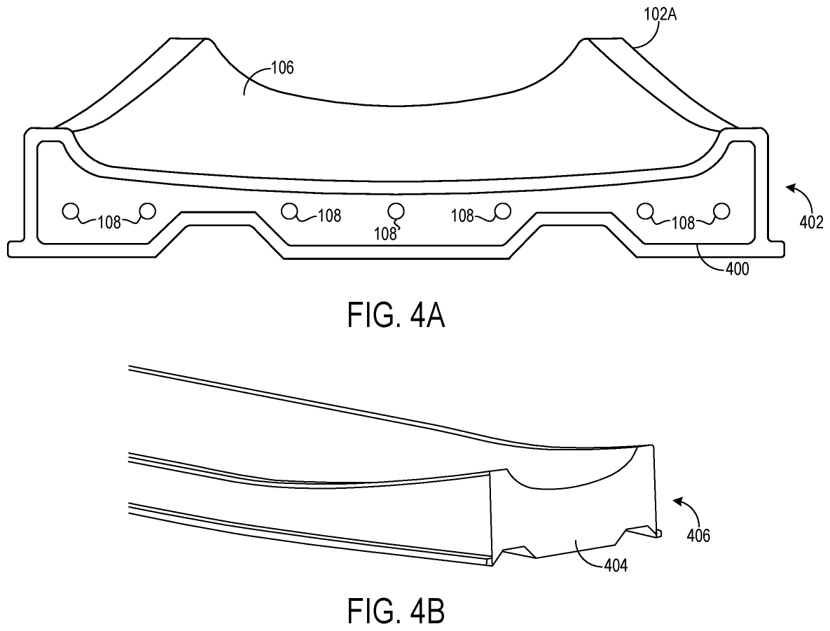

FIGS. 4A and 4B depict front and rear views, respectively, of article 102A. As shown in FIG. 4A, a front plate 400 is provided at a front end 402 of article 102A, with inlets 108 in the form of apertures being integrated in front plate 400. As described above, inlets 108 receive and provide fire suppressant to channels 104. In some examples, front plate 400 is fabricated separately from article 102A and affixed to body 106 via any suitable mechanism (e.g., an adhesive, screws, rivets, welding). In such examples, front plate 400 may comprise one or more metallic materials. In other examples, front plate 400 is integrally formed with article 102A during manufacture of the article.

As shown in FIG. 4B, a rear plate 404 is provided at the opposite rear end 406 of article 102A. As with front plate 400, rear plate 404 can be additively manufactured with body 106 or provided separately. In this example, rear plate 404 is a solid plate. Along with the front plate 400, rear plate 404 encloses channels 104 to provide desired sealing of pressurized suppressant therein. In other examples, and in addition to or instead of inlets 108 in front plate 400, rear plate 404 comprises inlets to receive and provide fire suppressant to channels 104. In these examples, the rear plate inlets are fluidically coupled to reservoir 300 or to another separate reservoir containing fire suppressant. Further and in other examples, where inlets are provided at a single plate, those inlets can be coupled to one or multiple different reservoirs.

In some implementations of a self-extinguishing additively manufactured article, fire suppressant is circulated through the channels of the article and between the article and a reservoir. FIG. 5 illustrates one such implementation in which channels 504 of an article 502A are pressurized with fire suppressant held by a reservoir 500. Reservoir 500 is fluidically coupled to inlets 508 via corresponding supply lines 512, whereby fire suppressant is provided to corresponding channels 504 in article body 506.

At the opposite end of article 502A, channels 504 are in fluidic communication with corresponding return lines 520 via outlets described in more detail below. The return lines 520 carry suppressant from the channels 504 back to reservoir 500. In this manner, suppressant can be continually circulated through channels 504 and between article 502A and reservoir 500. In various examples, pressurization and circulation of the suppressant is provided by any suitable mechanism, such as a pumping system 510.

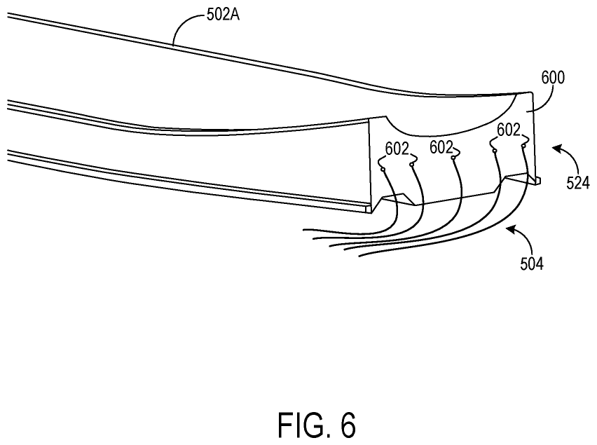

FIG. 6 shows a rear view of article 502A depicting a rear plate 600 at rear end 524 of article 502A. In different examples, rear plate 600 is either additively manufactured as an integral part of body 506 or provided separately and attached to body 506. Rear plate 600 includes a plurality of outlets 602. Outlets 602 are fluidically coupled to inlets 508 via channels 504. As noted above, each outlet 602 is fluidically coupled to reservoir 500 via a respective return line 520. In this manner, a fluidic circuit is formed between article 502A and reservoir 500 to enable the circulation of suppressant therebetween as described above.

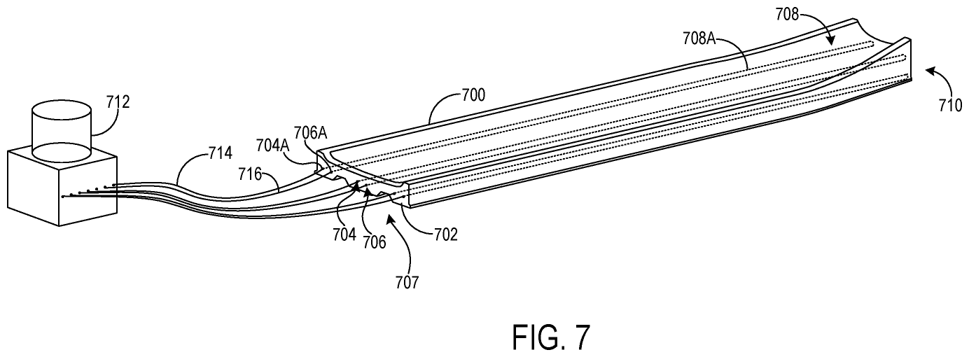

In some examples, inlets and outlets are provided at a common plate. FIG. 7 illustrates one such implementation in which an additively manufactured article 700 is provided with a front plate 702 that includes inlets 704 and outlets 706. In this example, inlets 704 and outlets 706 are in fluidic communication via corresponding channels 708 that extend from a front end 707 of article 700 to a rear end 710 and loop back to the front end, thereby fluidically coupling a corresponding inlet and outlet. As a particular example, a channel 708A fluidically couples an inlet 704A to an outlet 706A.

Each of the inlets 704 is fluidically coupled to a reservoir 712 via a respective supply line 714. Each outlet 706 is also fluidically coupled to the reservoir 712 via a respective return line 716, to thereby enable the circulation of fire suppressant between article 700 and reservoir 712.

In various examples, inlets and/or outlets can be provided at any suitable location in article 700. In some examples, and addition to or instead of inlets 704 and outlets 706 arranged at front plate 702, inlets and outlets are provided at a rear plate arranged at rear end 710 of the article 700. In different examples where inlets and outlets are provided at both plates, the rear inlets and outlets can fluidically couple to reservoir 712 or to another reservoir. In yet other examples, inlets and/or outlets can be provided at one or more lateral sides of article 700.

In the implementations discussed above, fire suppressant is delivered to channels integrated within the body of an article. The containment of pressurized suppressant within the channels provides a self-regulating and self-extinguishing mechanism in the presence of an ignition source. In particular, an aperture formed by the ignition source in a channel creates a pathway between a higher-pressure region inside the channel and a lower-pressure region outside the body. The pressurized suppressant flows from this higher pressure region to the lower pressure region and thus toward the ignition source, facilitating extinguishment of the ignition source.

In different examples, fire suppressant can be pressurized at any suitable pressure within a channel to facilitate this operation—for example, between approximately 5 psi and approximately 10 psi, or between approximately 5 psi and approximately 20 psi. Further, channel geometry may be selected to maintain desired backpressure in the event of a breach in the containment of pressurized suppressant in a channel, such that suppressant continues to flow at sufficient rates.

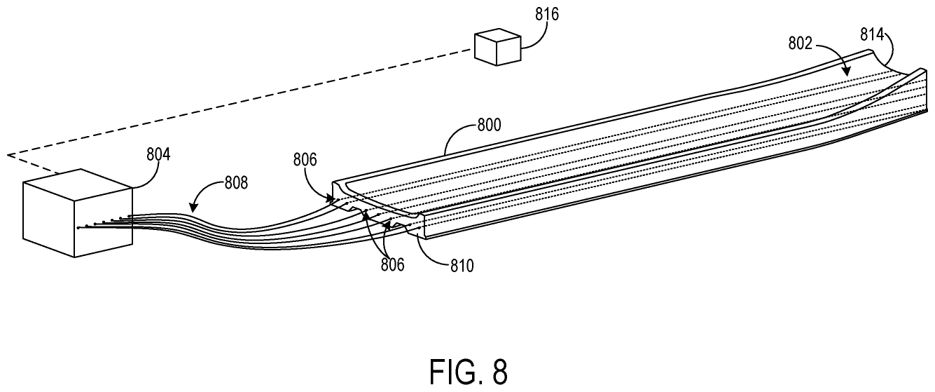

As described above, in some implementations fire suppressant is provided to the channels of an additively manufactured article on-demand when a fire risk is detected. In some examples, the article includes outlets configured to vent or spray the suppressant from article. FIG. 8 illustrates one such implementation in which an additively manufactured article 800 includes a plurality of integrated channels 802 that conduct fire suppressant received from a reservoir 804 including a pumping system. Reservoir 804 is fluidically coupled to a plurality of inlets 806 via respective supply lines 808, where each inlet 806 in turn is fluidically coupled to a corresponding channel 802.

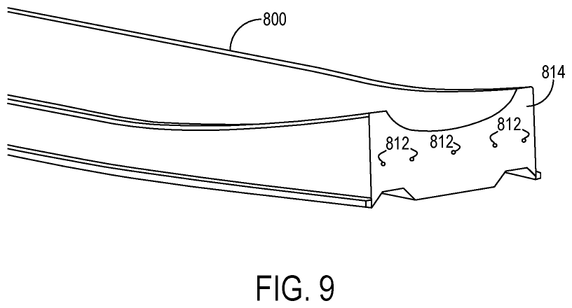

Inlets 806 are provided at a front plate 810 that can be integrally formed with article 800 or provided separately. As shown in FIG. 9, which depicts a rear view of article 800, a plurality of outlets 812 are provided at a rear plate 814 formed with or attached to article 800. Outlets 812 are in fluidic communication with corresponding inlets 806 via corresponding channels 802 and are open to atmosphere, thus enabling fire suppressant to be moved through the inlets and channels and expelled from the outlets.

Reservoir 804 supplies fire suppressant to the article 800 in response to a trigger indicating the presence of an ignition source. In some examples, reservoir 804 includes separate containers for water and a powder or liquid agent. In response to receiving a trigger, the reservoir 804 is caused to mix the water and powder/liquid to produce fire suppressant in the form of a foam, which is ducted through channels 802 and expelled from outlets 812. Any suitable mechanism may be used to trigger reservoir 804 to produce suppressant. As one example, FIG. 8 depicts a sensor 816 configured to detect the presence of an ignition source, and in response produce and send a trigger signal to reservoir 804. In one example, sensor 816 comprises an optical sensor (e.g., an infrared image sensor) configured to optically sense the presence of an ignition source.

In other examples, sensor 816 is utilized with an additively manufactured article that stores pressurized fire suppressant as described above, such as article 102A shown in FIGS. 1-4. In some of these examples, the sensor 816 includes a pressure or flow sensor configured to detect a pressure/flow drop in one or more channels of the article, and in response produce the trigger signal. In some examples, such a pressure or flow sensor is provided internally within the article. In these examples, a suitable orifice can be printed in the article to receive and house the pressure/flow sensor.

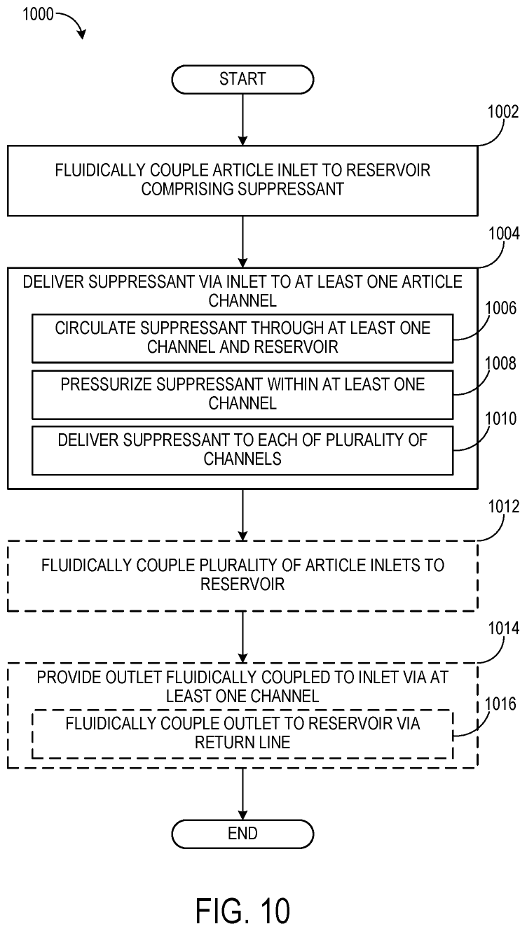

FIG. 10 shows a flowchart illustrating a method 1000 of mitigating fire risk in an additively manufactured article. Method 1000 may be implemented in connection with one or more of articles 102, 700, and 800, as examples.

At 1002, method 1000 includes fluidically coupling an inlet of the article to a reservoir comprising fire suppressant, the inlet also fluidically coupled to at least one channel of a plurality of channels integrated in a body of the article. At 1004, method 1000 includes delivering the fire suppressant via the inlet to the at least one channel. At 1006, delivering the suppressant can include circulating the suppressant through the at least one channel and the reservoir. For example, the suppressant can be circulated between the at least one channel and the reservoir via a supply line and a return line. At 1008, delivering the suppressant can include pressurizing the suppressant within the at least one channel. At 1010, delivering the suppressant can include delivering the suppressant to each channel of the plurality of channels.

At 1012, method 1000 can include fluidically coupling a plurality of inlets of the article to the reservoir. At 1014, method 1000 can include providing an outlet fluidically coupled to an inlet via at least one channel. At 1016, providing the outlet can include fluidically coupling the outlet to the reservoir via a return line.

In some examples, the additively manufactured articles described herein include one or more channels that perform functions other than conducting fire suppressant, in addition to at least one channel that conducts suppressant. As examples, such a channel can provide a vacuum, an air bearing (e.g., for moving the article without assistive devices such as a forklift or crane), a space for electronic components (e.g., power or signal supply lines, antennae, sensors), and/or a duct for heating and/or cooling. In one arrangement, a channel is provided around another channel (e.g., coaxially), wherein the outer channel conducts fire suppressant, while the inner channel performs a different function such as conducting a coolant. A coolant may be used to cool dies in a thermoforming process, as one example. Further, as described above, in some examples channels are formed at different layers within an article. In one such arrangement, channels at one layer can provide one or more of heating, cooling, and electrical conduction, while one or more channels in a different layer conduct fire suppressant.

The approaches described herein leverage an additive manufacturing process to produce articles with integrated channels that provide self-extinguishing capabilities. The channels mitigate risk associated with a flammable material composition of the additively manufactured article, which correspondingly reduces constraints on article storage and handling logistics, and increases article manufacturing throughput. The channels, by virtue of forming voids within articles, also reduce material consumption in article manufacturing and the final weight of manufactured articles.

The present disclosure includes all novel and non-obvious combinations and subcombinations of the various features and techniques disclosed herein. The various features and techniques disclosed herein are not necessarily required of all examples of the present disclosure. Furthermore, the various features and techniques disclosed herein may define patentable subject matter apart from the disclosed examples and may find utility in other implementations not expressly disclosed herein.

1. An additively manufactured article, comprising:
a body;
a plurality of channels integrated in the body;
an inlet fluidically coupled to at least one of the channels; and
pressurized fire suppressant in at least one of the channels.

2. The article of claim 1, wherein the inlet is fluidically coupled to a reservoir comprising the fire suppressant.

3. The article of claim 1, further comprising an outlet fluidically coupled to the inlet, wherein the pressurized fire suppressant is moved through the inlet and the outlet.

4. The article of claim 3, wherein the outlet is fluidically coupled to a reservoir via a return line, the reservoir comprising the fire suppressant.

5. The article of claim 3, wherein the outlet is open to atmosphere.

6. The article of claim 1, wherein the body comprises a thermoplastic material.

7. The article of claim 1, wherein the inlet comprises an aperture in a plate that is affixed to the body.

8. A method of mitigating fire risk in an additively manufactured article, the method comprising:
fluidically coupling an inlet of the article to a reservoir comprising fire suppressant, the inlet fluidically coupled to at least one channel of a plurality of channels integrated in a body of the article; and
delivering the fire suppressant via the inlet to the at least one channel.

9. The method of claim 8, further comprising fluidically coupling a plurality of inlets of the article to the reservoir, each of the plurality of inlets fluidically coupled to at least one channel of the plurality of channels.

10. The method of claim 8, wherein delivering the fire suppressant comprises circulating the fire suppressant through the at least one channel and the reservoir.

11. The method of claim 8, wherein delivering the fire suppressant comprises pressurizing the fire suppressant within the at least one channel.

12. The method of claim 8, further comprising providing an outlet that is fluidically coupled to the inlet via the at least one channel.

13. The method of claim 12, further comprising fluidically coupling the outlet to the reservoir via a return line.

14. The method of claim 12, wherein the outlet is open to atmosphere.

15. The method of claim 8, further comprising delivering the fire suppressant to each of the plurality of channels.

16. An additively manufactured article, comprising:
a body;
a plurality of channels integrated in the body; and
a plurality of inlets, wherein each inlet of the plurality of inlets is fluidically coupled to at least one of the channels, and each inlet of the plurality of inlets is fluidically coupled to a reservoir comprising fire suppressant.

17. The article of claim 16, further comprising a plurality of outlets fluidically coupled to the plurality of inlets, wherein the fire suppressant is moved through the plurality of inlets and the plurality of outlets.

18. The article of claim 17, wherein each of the plurality of outlets is fluidically coupled to the reservoir via a respective return line.

19. The article of claim 16, wherein the article comprises a thermoplastic material.

20. The article of claim 16, wherein the fire suppressant is pressurized in the plurality of channels.
